(19) United States
(12) Patent Application Publication
(10) Pub. No.: US 2001/0052204 A1
(43) Pub. Date: Dec. 20, 2001

(54) Wall segment for the wall of a cabin

(76) Inventors: Frank Schwenkler, Hildrizhausen (DE); G?uuml;nther Müller, Stuttgart (DE)

Correspondence Address: LAW OFFICE OF BARRY R LIPSITZ, 755 MAIN STREET, MONROE, CT, 06468, US

(21) Appl. No.: 09/745,895

(22) Filed: Dec. 21, 2000

(30) Foreign Application Priority Data
Dec. 22, 1999 (DE) 299 22 479.1

(51) Int. Cl. E04H 14/00; E06B 3/00

(52) U.S. Cl. 52/79.1; 52/204.5

(57) ABSTRACT

In order to provide a wall segment for a wall of a cabin, especially a cabin for a paint spraying plant, comprising a supporting construction which, for its part, comprises substantially vertically aligned posts and substantially horizontally aligned crossbeams, and planking which is held on the supporting construction and comprises a front face that faces the interior of the cabin when in its mounted state and extends over substantially the full height of the wall segment, and a window section arranged in the front face, which is easy to clean and is extremely reliable in operation, it is suggested that the front face of the planking is in the form of a plane surface free of horizontally extending bend- or fold-lines.

The present invention relates to a wall segment for a wall of a cabin, especially a cabin for a paint spraying plant, comprising a supporting construction which, for its part, comprises substantially vertically aligned posts and substantially horizontally aligned crossbeams, and planking which is held on the supporting construction and comprises a front face that faces the interior of the cabin when in its mounted state and extends over substantially the full height of the wall segment, and a window section arranged in the front face.

Wall segments of this type are known from the state of the art.

Therein, the window section serves for the purposes of enabling the interior of the cabin to be viewed from the exterior thereof or for illuminating the interior by means of a lamp arranged behind the window section.

In the known wall segments of this type, the planking is composed of a plurality of bent metal sheets or metal cassettes which delimit the window section, whereby, in their mounted state, these metal sheets incorporate a plurality of vertically aligned non-folded regions and a plurality of horizontally bent regions which are adjoined thereto along horizontally extending bend- or fold-lines. When the wall segments are being assembled, these metal sheets are connected together in pairs by placing the face areas of the horizontally bent regions of the relevant metal sheets together and fixing them to one another in a suitable manner, for example, by welding.

Due to the fact that the bend radii are not vanishingly small but have a finite size, the bend-lines at which the non-folded regions of the metal sheets merge into the horizontally bent regions are not sharply defined lines in the mathematical sense, but rather, they are curved regions which have a finite width transverse to their longitudinal direction. At the connection point between two metal sheets which are placed together at their horizontally bent regions, there thus ensues a horizontally extending channel which is delimited laterally by these bend- lines in the form of the curved regions of the interconnected metal sheets.

However, whilst the cabin is in operation, dirt and dust particles from the interior of the cabin collect in such horizontally extending channels which is especially disadvantageous for reason that such horizontal channels are very difficult to clean. The filling of the channels with a sealant does not provide a satisfactory solution since, over the required operational life of the cabin, such a sealant is not sufficiently resistant to the liquid media and/or the cleaning agents employed in the cabin.

Furthermore, such horizontal channels provide easy points of attack for the corrosive media, to which the front face of the wall segment is subjected during the operation of the cabin, so that in the region of such channels the corrosion can build up extremely rapidly thereby having adverse effects upon the operability of the cabin in unfavourable circumstances.

Consequently, the object of the present invention is to provide a wall segment for a wall of a cabin of the type described hereinabove, which is easy to clean and is extremely reliable in operation.

In accordance with the invention, this object is achieved in the case of a wall segment incorporating the features of the first part of claim 1 in that the front face of the planking is in the form of a plane surface free of horizontally extending bend- or fold-lines.

Since, in the case of the wall segment in accordance with the invention, the front face of the planking is not interrupted by horizontally extending fold lines, there are no horizontally extending channels, wherein dirt and dust particles from the interior of the cabin could collect, in the front face of the planking forming such a wall segment. Moreover the front face of the planking for the wall segment in accordance with the invention is easy to clean in a reliable manner.

Herein, a surface free of horizontally extending bend lines should be understood to mean a surface which is not traversed by horizontally extending bend lines; the front face of the planking of the wall segment in accordance with the invention may thus be bounded at its edges, especially at its upper and lower edge and at the edges of the window section in the front face, by horizontally extending bend lines.

It is particularly expedient, if, apart from horizontally extending bend lines, the front face of the planking is also free of bend lines extending transversely to the horizontal, i.e. if it is generally free of bend lines.

A front face for the planking free of horizontally extending bend lines may, for example, be obtained by forming the planking in one-piece from a single metal sheet. In this case the front face of the planking is formed by the front face of the non-folded region of the single metal sheet, so that for these reasons alone, there are no horizontally extending bend lines traversing the front face of the planking. Such a one-piece planking can be mounted in a particularly rapid and simple manner.

In an alternative embodiment of the wall section in accordance with the invention, provision may be made for the planking to be formed from at least two metal sheets which adjoin one another along their respective narrow sides, edge-to-edge (i.e. butt-jointed) and free of bends. The front faces of these metal sheets thereby flow into one another and, together, they form a plane front face of the planking which is free of horizontally extending bend lines.

Such an embodiment of the wall segment in accordance with the invention offers the advantage that plankings having a very large surface area (having a width of two metres for example and a height which corresponds to the usual height of a cabin of 4 m for example) can be composed of readily obtainable and economical sheets having a standard format (for example 1000 mm by 2000 mm, 1250 mm by 2500 mm or 1500 mm by 3000 mm) and one does not need to make use of sheets of excessive sizes.

In order to reliably prevent the formation of gaps between two abutting metal sheets, provision is advantageously made for the narrow sides of the abutting metal sheets to be fixed to one another. This can be affected by adhesion or welding, preferably by laser welding.

In order to make provision for a window section which corresponds in width to the standard form of cabin lighting obtainable on the market, the planking of the wall segment preferably has a width of at least 1.5 m, and preferably a width of at least 1.9 m.

In order to form planking having a width of 1.5 m or more, a single metal sheet having an appropriate special format is used, or the planking is composed of several metal sheets of standard format.

In order to exclude points of leakage insofar as this is possible, it is expedient for the window section of the planking to have rounded edge regions.

In those cases where the wall segment comprises a transparent pane arranged behind the window section, preferably of glass, and a ring-like closed seal is arranged between the pane and the planking, it is expedient for the ring-like closed seal to be formed by a substantially linear sealing element which extends between a front end-face and a rear end-face thereof, whereby the front end-face and the rear end-face of the sealing element abut one another. The ring-like closed seal thereby comprises only a single connecting point whereby the danger of having several points of leakage is reduced.

The front end-face and the rear end-face of the sealing element may be connected together by an adhesive or by vulcanising the sealing element.

In a preferred embodiment of the invention, provision is made for the front end-face and the rear end-face of the sealing element to be arranged behind an upper edge of the window section. Firstly, this then ensures that the connecting point of the sealing element is located out of sight of people in the interior of the cabin. In addition, liquid media trickling down the front face of the planking will drop down from the upper edge of the window section without coming into contact with the connecting point of the sealing element, so that this connecting point will only be attacked to a minor extent by such possibly aggressive liquid media.

In order to increase the stiffness of the planking and thus that of the whole wall segment, it is advantageous for the planking to comprise at least one reinforcing region which adjoins a front wall region of the planking facing the interior of the cabin along an edge of the window section.

It is particularly expedient if such a reinforcing region of the planking extends substantially parallel to the crossbeams of the supporting structure.

Steel plates, which may be coated and/or zinc-plated, thermally aluminised sheets, or sheets of non-ferrous materials or combinations of these various materials could, for example, be considered for use as materials for the planking and the supporting structure of the wall segment.

Since the front face of the planking facing the interior of the cabin may be subjected to corrosion enhancing media, for example fully desalinised water, the planking is manufactured from a corrosion resistant material, preferably a high-grade steel, in a preferred embodiment of the wall segment in accordance with the invention.

In order to protect the supporting construction insofar as possible from the effects of such corrosion enhancing media in the interior of the cabin, it is expedient for the planking to cover the supporting construction, preferably completely, towards the interior of the cabin.

In this case, the supporting construction can be manufactured from a material which has a lower corrosion resistance, but thereagainst, a lower specific gravity than the material of the planking.

In particular, provision may be made for the supporting construction to be manufactured from aluminium.

Further features and advantages of the invention form the subject matter of the following description and illustrations of embodiments thereof.

In the drawings

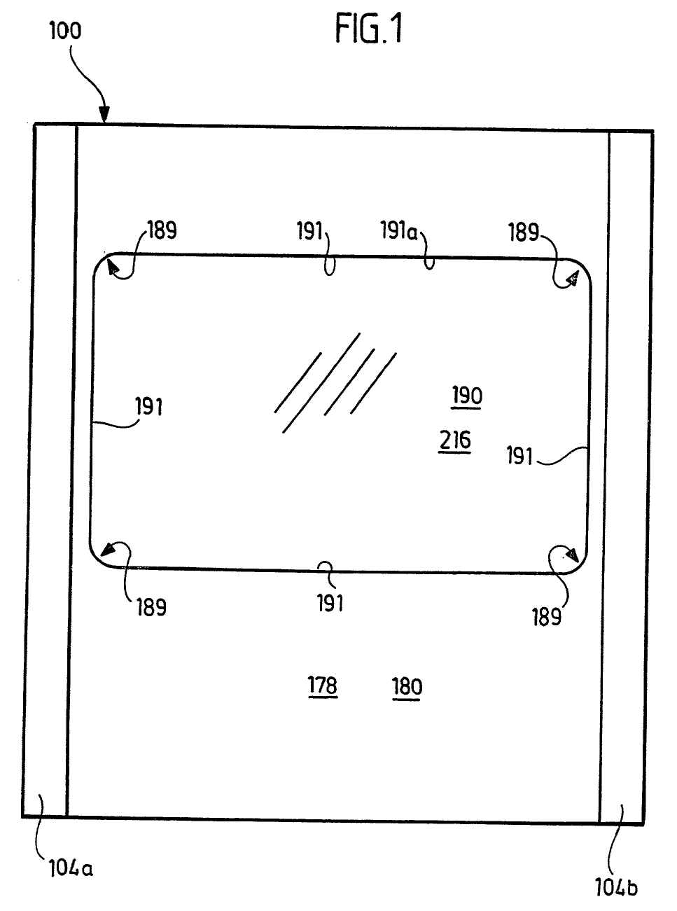

FIG. 1 shows a front view of a first embodiment of a wall segment;

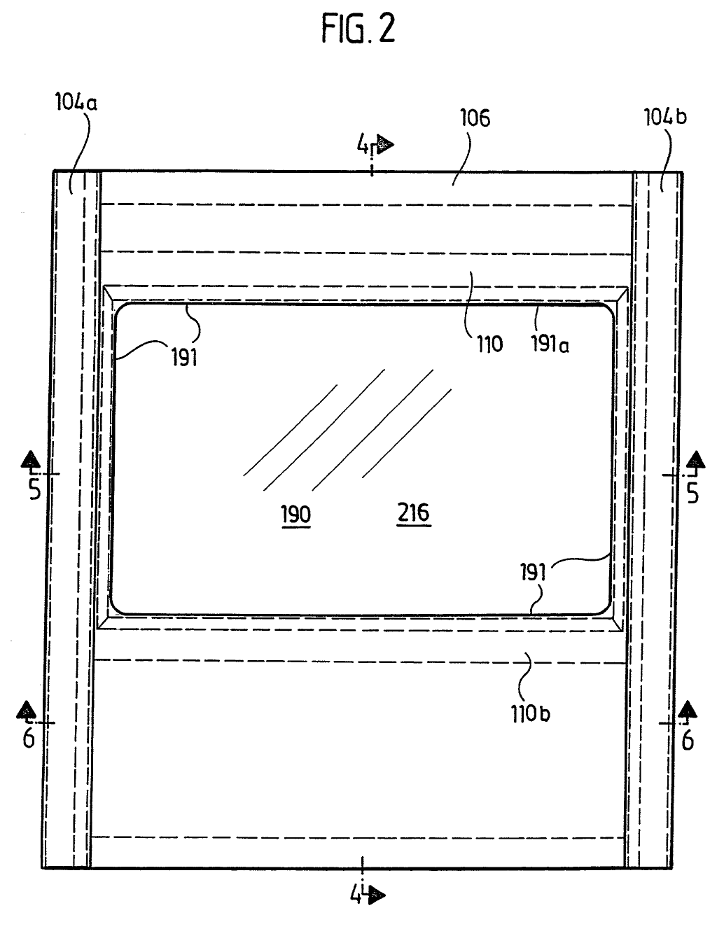

FIG. 2 a front view similar to FIG. 1 but additionally illustrating hidden lines;

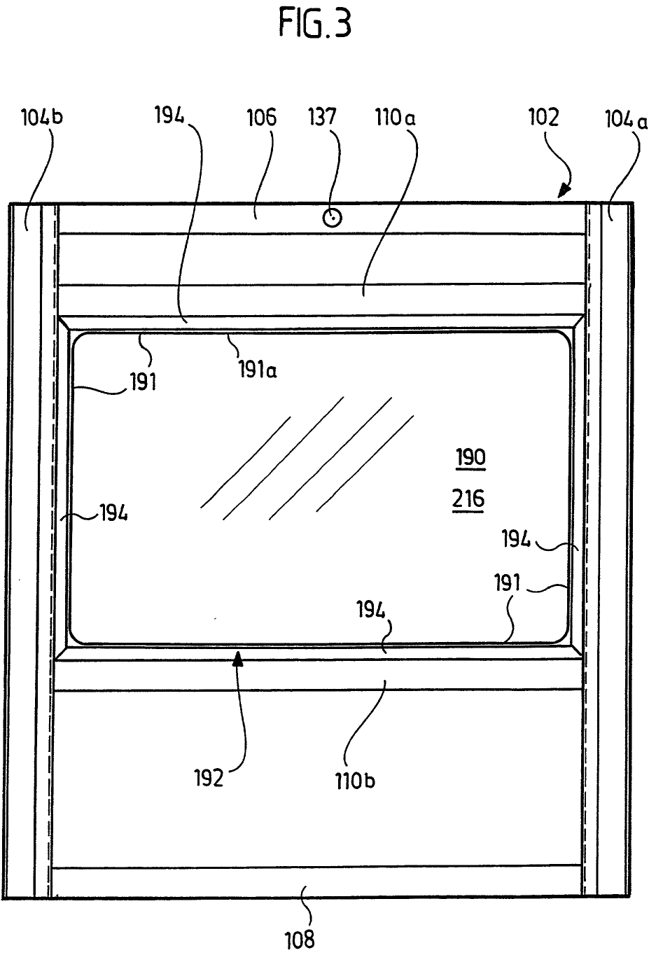

FIG. 3 a rear view of the first embodiment of a wall segment;

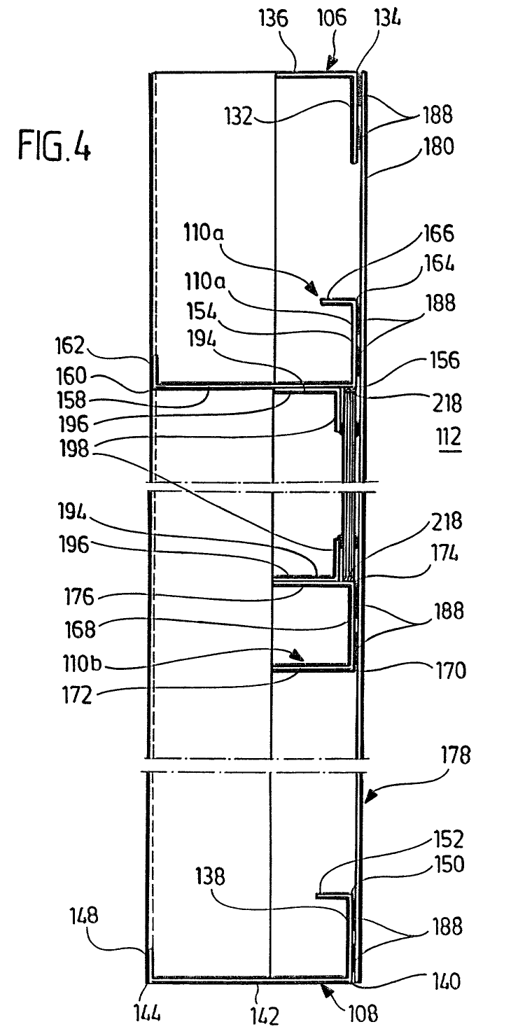

FIG. 4 a vertical section through the first embodiment of a wall segment along the line 4-4 in FIG. 2;

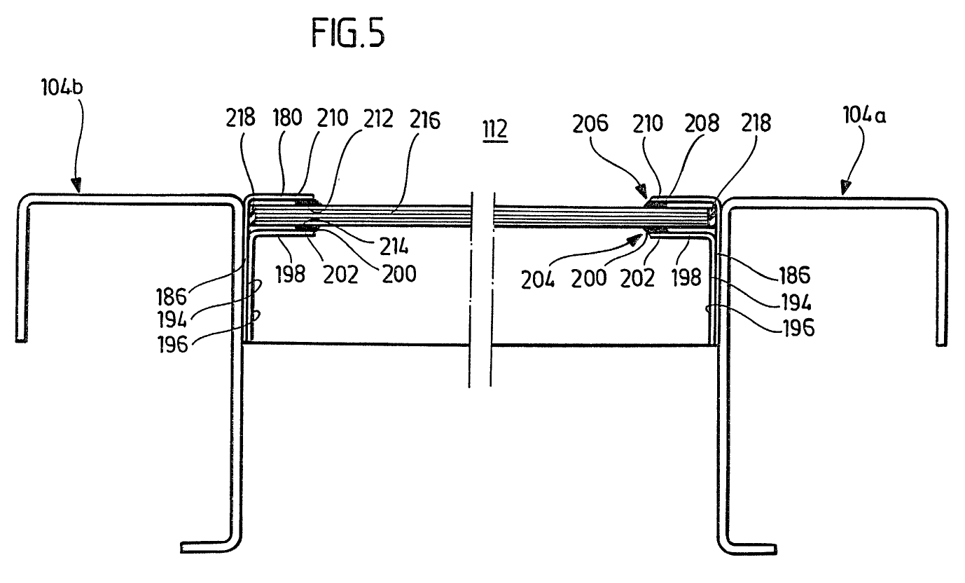

FIG. 5 a horizontal section through the first embodiment of a wall segment along the line 5-5 in FIG. 2;

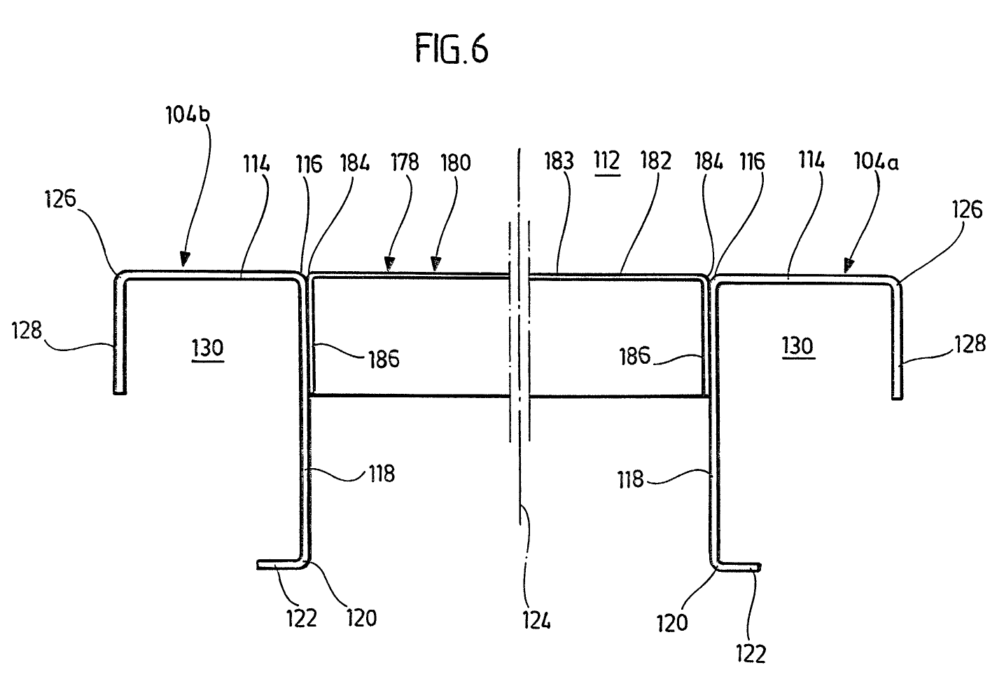

FIG. 6 a horizontal section through the first embodiment of a wall segment along the line 6-6 in FIG. 2;

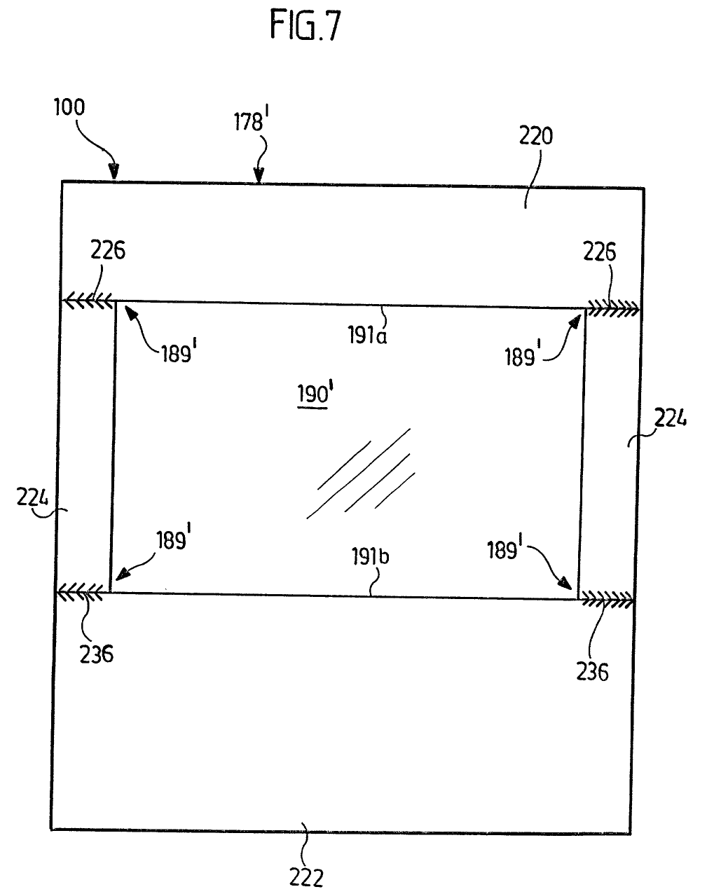

FIG. 7 a front view of a second embodiment of a wall segment;

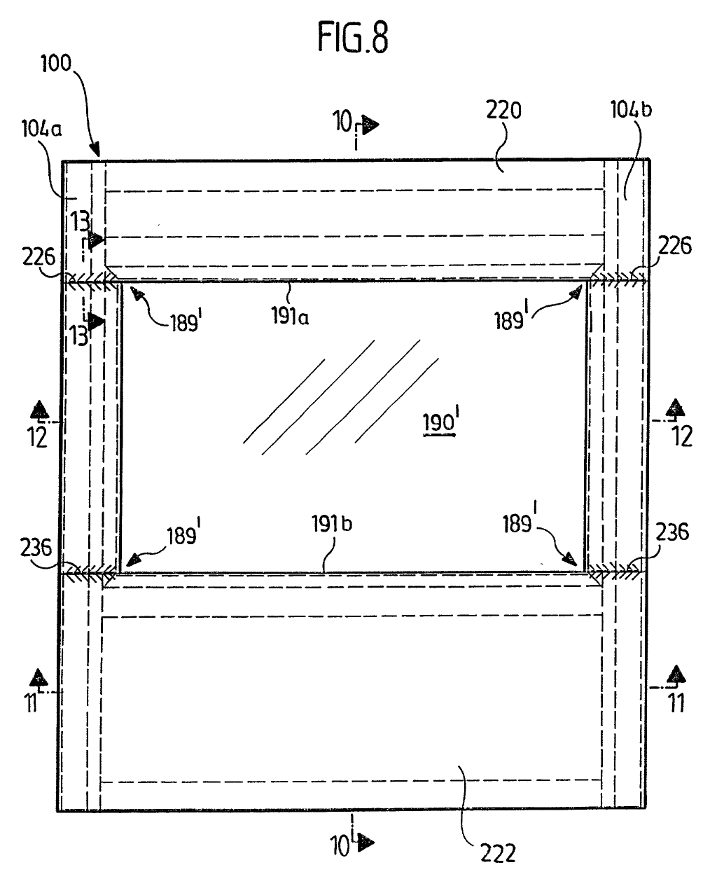

FIG. 8 a front view similar to FIG. 7, but additionally illustrating hidden lines;

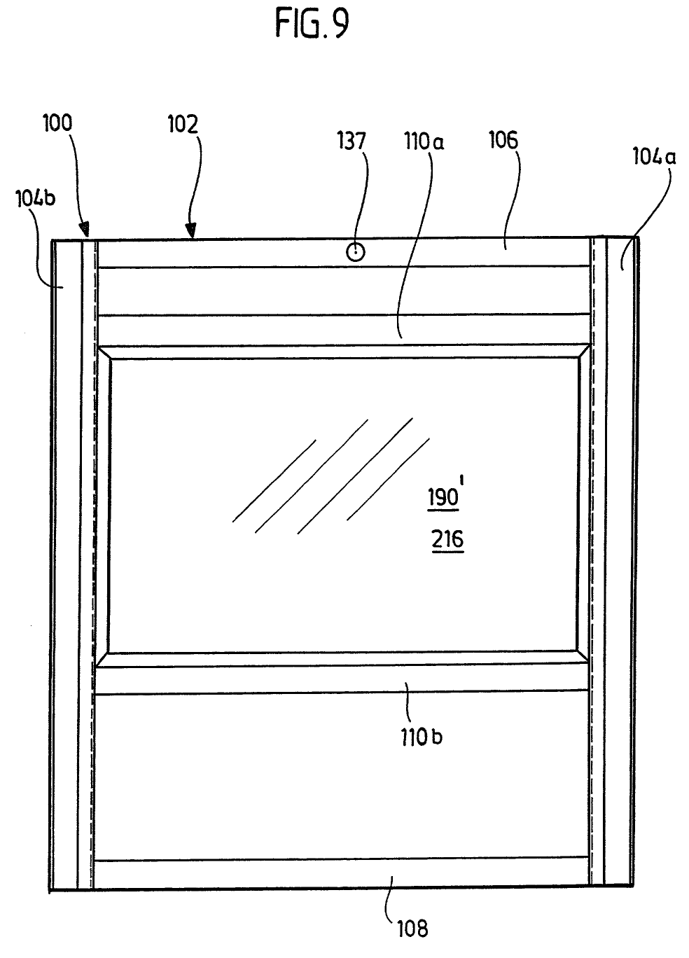

FIG. 9 a rear view of the second embodiment of a wall segment;

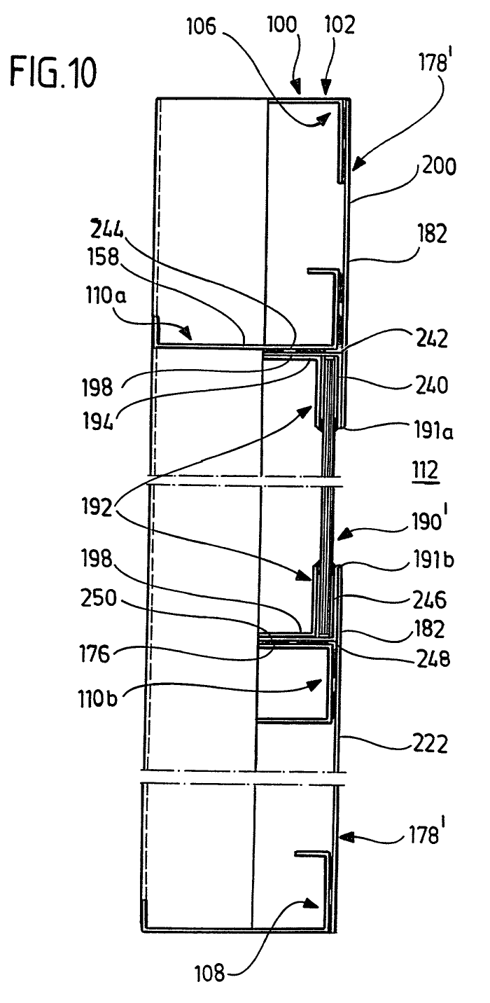

FIG. 10 a vertical section through the second embodiment of a wall segment along the line 10-10 in FIG. 8;

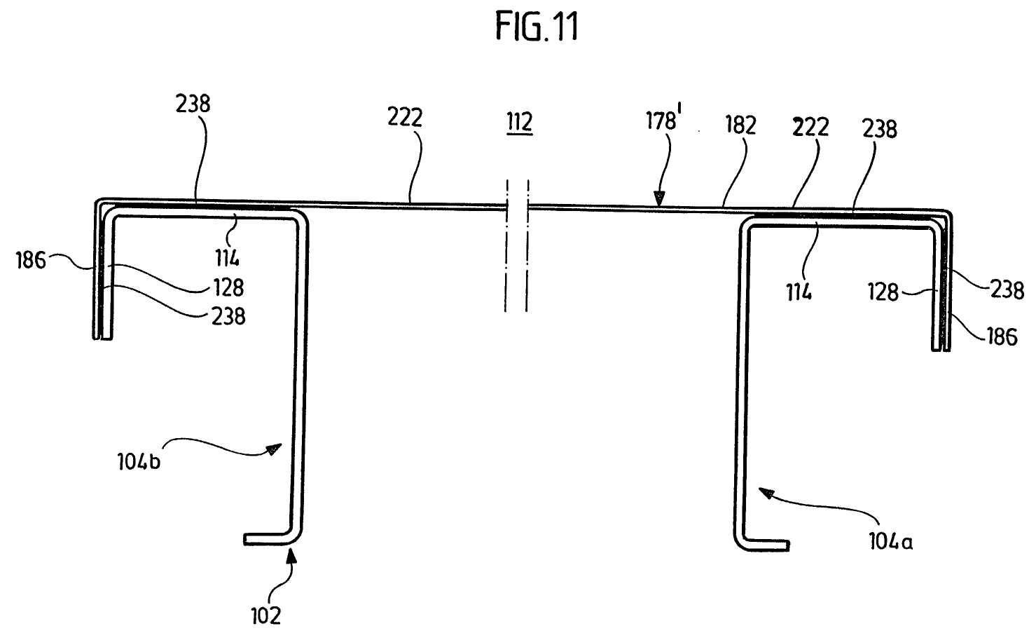

FIG. 11 a horizontal section through the second embodiment of a wall segment along the line 11-11 in FIG. 8;

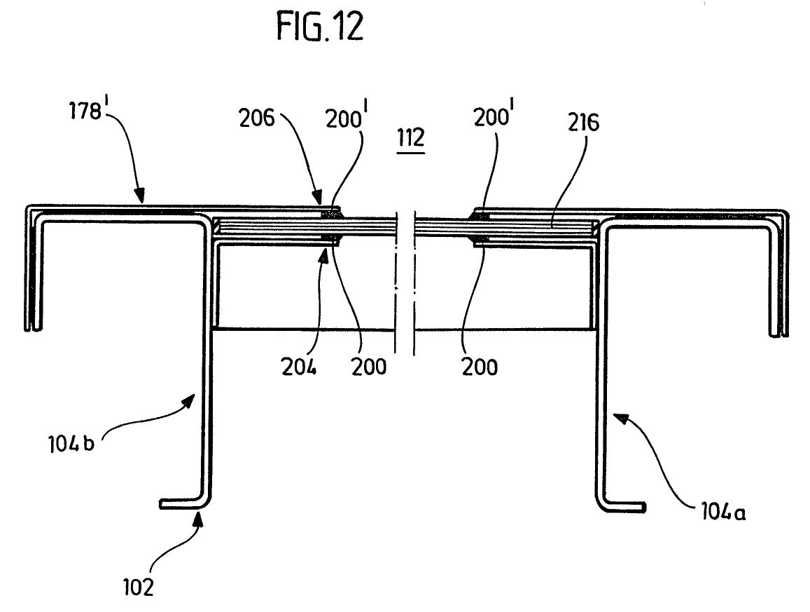

FIG. 12 a horizontal section through the second embodiment of a wall segment along the line 12-12 in FIG. 8; and

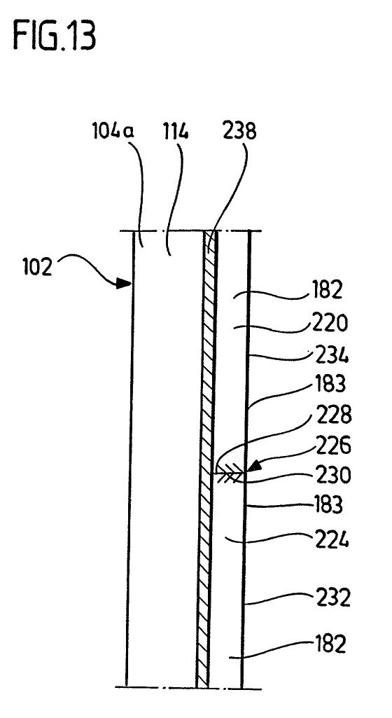

FIG. 13 a vertical section through a post of the supporting construction and through the planking of the second embodiment of a wall segment in a region in which two metal sheets of the planking engage edge-to-edge, along the line 13-13 in FIG. 8.

Similar or functionally equivalent elements are referenced with the same reference symbols in each of the Figures.

A first embodiment illustrated in FIGS. 1 to 6 of a wall segment bearing the general reference 100 for the wall of a cabin of a paint spraying plant comprises a substantially rectangular supporting construction 102 (see FIG. 3), which, for its part, comprises a left (as seen from the interior 112 of the cabin) vertical post 104a and a right vertical post 104b, a horizontal upper crossbeam 106 extending therebetween at the upper ends of the posts 104a, 104b, a horizontal lower crossbeam 108 extending therebetween at the lower ends of the posts 104a, 104b, and also two horizontal transverse crossbeams 110a and 110b extending from the one post 104a to the other post 104b between the upper crossbeam 106 and the lower crossbeam 108.

As can best be seen from the horizontal section shown in FIG. 6, each of the posts 104a, 104b is in the form of a sheet metal profile having a constant cross-section in the respective vertical longitudinal direction of the post 104a, 104b.

Each of the posts 104a, 104b comprises a front wall region 114 facing the interior 112 of the cabin and an inner side wall region 118, which extends rearwardly from and perpendicularly to the front wall region 114 and adjoins an inner edge of the front wall region 114 along a vertical fold line 116.

At this point and hereinafter, the surfaces and components of an element of the wall segment 100 facing the interior 112 of the cabin will be referred to as its front surfaces or components, and the surfaces and components of an element remote from the interior 112 of the cabin will be referred to as its rear surfaces or components.

A rear wall region 122 adjoins a rear edge of the inner side wall region 118 of the vertical post 104a, 104b along a vertical fold line 120 and extends perpendicularly outwards from the inner side wall region 118, namely away from the transverse mid plane 124 of the wall segment 100.

Furthermore, an outer side wall region 128 adjoins the outer edge of the front wall region 114 of each post 104a, 104b along a vertical fold line 126, and extends perpendicularly rearwards from the front wall region 114.

As can be seen from FIG. 6, the horizontal extension of the rear wall region 122 is smaller than that of the front wall region 114 and the horizontal extension of the outer side wall region 128 is smaller than that of the inner side wall region 118, so that a passage opening is produced between the free edges of the rear wall region 122 and the outer side wall region 128, the interior 130 of the relevant post 104a, 104b being accessible from the rear face of the wall segment 100 via said passage opening. This passage opening is closed by means of a (not illustrated) cover mounted on the respective posts 104a, 104b. The crossbeams 106, 108, 110a on 110b also have a cross-section which is constant in the longitudinal direction thereof, as can be seen from FIG. 4.

The upper crossbeam 106 comprises a vertical front wall region 132 whose upper edge adjoins a roof wall region 136 along a horizontal fold line 134, said roof wall region 132 extending rearwardly from the front wall region 132 in a horizontal direction.

The front wall region 132 is provided with a central boring 137 into which a hole-making tool, for example a boring or stamping tool, can be inserted so as to produce a break-through in the planking of the cabin through which media conduits, for example, sprinkler lines or electrical supply or control leads can be fed.

The lower crossbeam 108 comprises a vertical front wall region 138 whose lower edge adjoins a base wall region 114 along a horizontal fold line 140, said base wall region extending horizontally rearwards from the front wall region 138.

A rear wall region 148 adjoins a rear edge of the base wall region 142 along a horizontal bend line 144 and extends vertically upwards from the base wall region 142.

Furthermore a horizontal wall region 152 borders the upper edge of the front wall region 138 of the lower crossbeam 108 along a horizontal fold line 150, said wall region 152 extending horizontally rearwards from the front wall region 138 but to a lesser extent than the base wall region 142.

The upper intermediate crossbeam 110a comprises a vertical front wall region 154 whose lower edge adjoins a lower horizontal wall region 158 along a horizontal bend line 156, said wall region 158 extending rearwardly from the front wall region 154 in a horizontal direction.

A vertical rear wall region 162, which extends vertically upwards from the lower horizontal wall region 158, adjoins the rear edge of the lower horizontal wall region 158 along a horizontal bend line 160.

An upper horizontal wall region 166, which extends horizontally rearwards from the front wall region 154 but to a lesser extent than the lower horizontal wall region 158, adjoins the upper edge of the front wall region 154 of the upper transverse crossbeam 110a along a horizontal bend line 164.

The lower intermediate crossbeam 110b, which extends horizontally rearwards from the front wall region 168, comprises a vertical front wall region 168 whose lower edge adjoins a lower horizontal wall region 172 along a horizontal bend line 170.

Furthermore, an upper horizontal wall region 176, which extends horizontally rearwards from the front wall region 168, namely over the same path as the lower horizontal wall region 172, adjoins the upper edge of the front wall region 168 of the lower transverse crossbeam 110b along a horizontal bend line 174.

Said vertical and horizontal bend lines are not thereby ideal lines in a mathematical sense because of their finite bend radii, but form a longitudinally extending curved region of finite width.

The crossbeams 106, 108, 110a and 110b are fixed to the inner side wall regions 118 of the posts 104a and 104b at their end-face ends with the aid of suitable fastening means so as to form the supporting construction 102 of the wall segment 100.

In the regions where the crossbeams join the posts 104a and 104b, the inner side wall regions 118 of the posts 104a, 104b comprise breakthroughs for allowing the introduction of media conduits and/or electrical supply or control leads.

As previously described, the crossbeams 106, 108, 110a and 110b are in the form of open profile elements towards the exterior of the cabin. These crossbeams can be closed by means of (not illustrated) covers towards the exterior of the cabin.

The planking 178 of the wall segment 100, which is formed from a single metal sheet 180 in the first embodiment of the wall segment 100 illustrated in FIGS. 1 to 6, is mounted on this supporting construction 102.

As can best be seen from FIG. 6, the metal sheet 180 comprises a plane vertical front wall region 182 whose lateral edges adjoin the vertical side wall regions 186 along vertical bend lines 184, whereby said side wall regions 186 extend rearwardly from the front wall region 182 and abut the inner side wall regions 118 of the posts 104a and 104b, whilst the front face 183 of the front wall region 182 of the metal sheet 180 lies in the same plane as the front faces of the front wall regions 114 of the posts 104a, 104b.

The plane front face 183 of the planking 178 formed from the metal sheet 180 extends over a width of approximately 2 m and over the total height of the wall segment 100.

Furthermore, as can best be seen from FIG. 4, the metal sheet 180 is fitted from the front, via adhesive layers 188, to the front wall regions 132, 154, 168 and 138 of the upper crossbeam 106, the upper intermediate crossbeam 110a, the lower intermediate crossbeam 110b and the lower crossbeam 108, and is thereby fixed to the supporting construction 102.

In the first embodiment, as can best be seen from the front view in FIG. 1, the metal sheet 180 of the planking 178 merely extends between the posts 104a and 104b but does not cover them towards the interior 112 of the cabin so that the front face of the wall segment 100 facing the interior 112 of the cabin is formed by the front faces of the posts 104a, 104b and by the front face 183 of the metal sheet 180.

A substantially rectangular window section 190 having rounded edge regions 189 is provided in the front wall region 182 of the metal sheet 180.

As can best be seen from FIG. 3, a substantially rectangular mounting frame 192 is arranged behind the planking 178, said frame being composed of four, mitred, frame profile elements 194 each of which has an L-shaped cross-section comprising a bearing leg 196 and a mounting leg 198 (see FIG. 5).

Hereby, the bearing legs 196 abut the upper horizontal wall region 176 of the lower intermediate crossbeam 110b, the lower horizontal wall region 158 of the upper intermediate crossbeam 110a and one of the side wall regions 186 of the metal sheet 180 (see FIG. 5) and they are fixed to these wall regions by means of suitable fastening means, preferably in a releasable manner.

The mounting legs 198 of the frame profile elements 194 project out from the front edges of the bearing legs 196 in such a manner that their free edges remote from the respective bearing legs 196 flow into the edges 191 of the window section 190.

As can best be seen from FIGS. 4 and 5, the mounting legs 198 of the frame profile elements 194 are each provided with a resilient rear sealing element 200 which extends in parallel to the free edge of the respective mounting leg 198 and has a substantially constant trapezoidal cross-section in the longitudinal direction thereof.

Each of the rear sealing elements 200 is provided in its rear face facing the respective frame profile element 194 with a recess 202 which extends in the longitudinal direction thereof and has a substantially rectangular cross-section and is used for accommodating the free edge of the mounting leg 198 of the respectively associated frame profile element 194.

Each of the rear sealing elements 200 is fixed to its respective frame profile element 194 by means of a double-sided sticky tape comprising an adhesive on an acrylate base for example.

Together, the four rear sealing elements 200 form a rectangular ring-like closed rear seal 204.

The edges 191 of the window section 190 of the planking 178 are also provided with a front seal 206, this, however, is formed from a single resilient front sealing element 208 that extends around the lower periphery of the window section 190 along the edges 191 and has a constant cross-section in the longitudinal direction thereof which is substantially trapezoidal in shape and comprises a recess 210 having a rectangular cross-section for accommodating the edges 191 of the window section 190 on the side thereof facing the planking 178.

The front sealing element 208 has a (not illustrated) front end-face and a (not illustrated) rear end-face which abut, edge-to-edge, in the region of the upper edge 191a of the window section 190 so that the front sealing element 208 is closed in ring-like manner, these end-faces then being fixed together by means of a suitable adhesive.

The plane rear face of the front sealing element 208 remote from the planking 178 and the plane front faces of the rear sealing elements 200 remote from the mounting frame 192 respectively form a front clamping surface 212 and a rear clamping surface 214 between which a rectangular glass pane 212 is held.

The glass pane 216 is supported by means of spacer elements 218, of which at least two are arranged along each edge of the glass pane 216, laterally on the side wall regions 186 of the metal sheet 180, downwardly on the lower horizontal wall region 176 of the lower intermediate crossbeam 110b and upwardly on the lower horizontal wall region 158 of the upper intermediate crossbeam 110a.

A (not illustrated) lamp is arranged behind the glass pane 216 at the height of the window section 190 and extends over virtually the whole width of the window section 190.

A portion of the interior 112 of the cabin can be illuminated through the glass pane 216 and the window section 190 by means of this lamp when the cabin is operational.

In order to form a side wall of the cabin, a plurality of the previously described wall segments 100 are arranged next to each other in such a manner that the vertical posts 104a, 104b abut one another at their outer side wall regions 128. These abutting, outer side wall regions 128 of the posts 104a, 104b in neighbouring wall segments 100 are fixed to one another by suitable fastening means, for example, by means of nuts and bolts, or by welding.

A second embodiment of a wall section 100 illustrated in FIGS. 7 to 13 differs from the previously described first embodiment in that the planking 178′ in the second embodiment is not formed in one piece from a single metal sheet, but is composed of a plurality of metal sheets, namely an upper metal sheet 220 which forms a region of the planking 178′ arranged above the window section 190′, a metal sheet 222 which forms a lower region of the planking 178′ arranged below the window section 190′, and two lateral metal sheets 224 which form regions of the planking 178′ arranged latterly of the window section 190′ and connect the upper metal sheet 220 and the lower metal sheet 222 together.

Here, the upper narrow sides 228 of the front wall regions 182 of the lateral metal sheets 224 continuously abut, edge-to-edge and in bend-free manner, the lower narrow sides 230 of the front wall region 182 of the upper metal sheet 220 along the horizontal seating lines 226 which extend at the same height as the upper edge 191a of the window section 190′ (see FIG. 13). In this position, the lateral metal sheets 224 are connected to the upper metal sheet 220, e.g. by laser welding, in such a manner that, together, the front faces 232 of the lateral metal sheets 224 and the front face 234 of the upper metal sheet 220 form a continuous substantially plane, bend-line-free front face 183 of the planking 178′.

The metal sheets 224 and 220 are held on the supporting construction 102, on the post 104a for example, by means of adhesive layers 238 (see FIG. 13).

The lateral metal sheets 224 are connected to the lower metal sheet 222 in a corresponding manner along horizontal seating lines 236 which extend at the height of the lower edge 191b of the window section 190′.

Furthermore, the second embodiment of the wall section 100 differs from the first embodiment in that the planking 178′ in the second embodiment covers the posts 104a and 104b of the supporting construction 102 towards the interior 112 of the cabin, as can best be seen from FIGS. 7, 11 and 12.

As can be seen from FIG. 11, the rear face of the front wall region 180 of the lower metal sheet 222 is joined to the front wall regions 114 of the posts 104a, 104b via a layer of adhesive 238.

Furthermore, the side wall regions 186 of the lower metal sheet 222 are joined to the outer side wall regions 128 of the posts 104a, 104b via adhesive layers 238.

The lower metal sheet 222 is fixed to the posts 104a, 104b of the supporting construction 102 by means of the adhesive layers 238.

The upper metal sheet 220 and the lateral metal sheets 224 are also held on the post 104a and/or on the post 104b in a corresponding manner. Since, in the second embodiment of the wall section 100, it is only the planking 178′ formed from the metal sheets 220, 222 and 224 that borders the interior 112 of the cabin whereas the supporting construction 102 does not, it is sufficient in the second embodiment to produce the components of the planking 178′ from a corrosion resistant material, for example from high-grade steel.

By contrast, the supporting construction 102 may be made of a material which has a lower corrosion resistance, but thereagainst, one which has a lower specific gravity than the material of the planking 178′. In particular, the supporting construction 102 of the second embodiment may be made from aluminium.

As can be seen from the sectional illustration in FIG. 10, the upper metal sheet 220 of the planking 178′ may be folded upwardly along the upper edge 191a of the window section 190′ so that a vertical reinforcing region 240 of the upper metal sheet 220 will extend upwardly from the upper edge 191a of the window section 190′ and a large surface area thereof will rest on the front wall region 182 of the upper metal sheet 220.

A horizontal wall region 244 of the upper metal sheet 220 adjoins the upper edge of the reinforcing region 240 along a horizontal fold line 242, which extends horizontally rearwards from the reinforcing region 240 and abuts, from below, the lower horizontal wall region 158 of the upper intermediate crossbeam 110a, and from above, the bearing leg 198 [sic] of the upper frame profile element 194 of the mounting frame 192.

In a corresponding manner, the lower metal sheet 222 also comprises a vertical reinforcing region 246 which extends downwardly from the lower edge 191b of the window section 190′ and abuts, from behind, the front wall region 182 of the lower metal sheet 222.

The lower metal sheet 222, which extends rearwardly in a horizontal direction perpendicular to the reinforcing region 246, borders the lower edge of the reinforcing region 246 along a horizontal bend line 248 and abuts, from above, the upper horizontal wall region 176 of the lower intermediate crossbeam 110b, and from below, the bearing leg 198 [sic] of the lower frame profile element 194 of the mounting frame 192.

The reinforcing regions 240, 246 running parallel to the crossbeams 106, 108 and 110a, 110b of the supporting construction 102 and the horizontal wall regions 244, 250 of the upper metal sheet 220 and the lower metal sheet 222 contribute to the increased stiffness of the planking 178′ and thus to that of the wall segment 100 of the second embodiment.

Furthermore, the second embodiment of the wall segment 100 differs from the first embodiment in that the window section 190′ comprises non-rounded rectangular corner regions 189′, and in that the front seal 206 between the planking 178′ on the one hand, and the glass pane 216 on the other are not formed from a single, ring-like closed sealing element, but rather, just as for the rear seal 204, from four sealing elements 200′ each extending along a respective edge 191 of the window section 190′.

As regards the construction and functioning of the second embodiment of the wall segment 100, these otherwise correspond to those of the first embodiment so that in this respect reference should be made to the preceding description.

The present disclosure relates to the subject matter disclosed in German Utility Model Application No. 299 22 479.1 of Dec. 22, 1999, the entire specification of which is incorporated herein by reference.

1. A wall segment for a wall of a cabin, especially a cabin for a paint spraying plant, comprising
a supporting construction which comprises substantially vertically aligned posts and substantially horizontally aligned crossbeams, and
planking that is held on the supporting construction and comprises a front face, which extends over substantially the full height of the wall segment and faces the interior of the cabin when in its mounted state, and also comprises a window section which is arranged in the front face,
wherein the front face of the planking is in the form of a plane surface free of horizontally extending bend-lines.

2. A wall segment in accordance with claim 1, wherein the planking is formed in one piece from a single metal sheet.

3. A wall segment in accordance with claim 1, wherein the planking is formed from at least two metal sheets whose respective narrow sides abut one another edge-to-edge and without bends.

4. A wall segment in accordance with claim 3, wherein the narrow sides of the abutting metal sheets are attached to one another, preferably by welding.

5. A wall segment in accordance with claim 1, wherein the planking has a width of at least 1.5 m, and preferably, a width of at least 1.9 m.

6. A wall segment in accordance with claim 1, wherein the window section in the planking comprises rounded corner regions.

7. A wall segment in accordance with claim 1, wherein the wall segment incorporates a transparent pane, preferably of glass, which is arranged behind the window section, in that a ring-like closed seal is arranged between the pane and the planking, and in that the ring-like closed seal is formed by a substantially linear sealing element extending between a front end-face and a rear end-face, whereby the front end-face and the rear end-face of the sealing element abut one another.

8. A wall segment in accordance with claim 7, wherein the front end-face and the rear end-face of the sealing element are arranged behind an upper edge of the window section.

9. A wall segment in accordance with claim 1, wherein the planking comprises at least one reinforcing region which borders a front wall region of the planking facing the interior of the cabin along an edge of the window section.

10. A wall segment in accordance with claim 9, wherein the reinforcing region of the planking extends substantially in parallel with the crossbeams of the supporting construction.

11. A wall segment in accordance with claim 1, wherein the planking is manufactured from a corrosion resistant material, preferably from high-grade steel.

12. A wall segment in accordance with claim 1, wherein the planking covers, preferably completely, the supporting construction towards the interior of the cabin.

13. A wall segment in accordance with claim 12, wherein the supporting construction is manufactured from a material which has a lower specific gravity and/or a smaller corrosion resistance than the material of the planking.

14. A wall segment in accordance with claim 13, wherein the supporting construction is manufactured from aluminium.
